(19) United States
(12) Patent Application Publication
(10) Pub. No.: US 2018/0168107 A1
(43) Pub. Date: Jun. 21, 2018

(54) SYSTEM AND METHODOLOGY THAT FACILITATES COMMERCIAL SCALE IRRIGATION VIA PLANT INJECTION

(71) Applicant: Viper Irrigation Technology, LLC., Fresno, CA (US)

(72) Inventor: Phillip Christensen, Fresno, CA (US)

(21) Appl. No.: 15/385,543

(22) Filed: Dec. 20, 2016

(51) Int. Cl. A01G 7/06; A01G 27/00; A01G 1/00; A01G 17/02; A01C 23/04; A01G 13/06; A01C 21/00; A01G 29/00

(52) U.S. Cl. CPC A01G 7/06; A01G 27/003; A01G 1/001; A01G 29/00; A01C 23/04; A01G 13/06; A01C 21/00; A01G 17/02

(57) ABSTRACT

An irrigation system is disclosed, which includes a pressurized fluid source having at least one fluid output line, and a plurality of fluid lines coupled to the at least one fluid output line. Here, each of the fluid lines comprise an injectable nozzle configured to inject fluid into an outer xylem layer of a dicotyledon plant, and the pressurized fluid source maintains a pressure level that facilitates the injection of fluid via a transpiration of the dicotyledon plant. A method and computer-readable storage medium are also disclosed, which facilitate various acts. The method facilitates maintaining a pressure level at the pressurized fluid source, and injecting the injectable nozzle into the outer xylem layer of the dicotyledon plant. The computer-readable storage medium facilitates maintaining the pressure level at the pressurized fluid source, monitoring a characteristic associated with the injection of fluid, and communicating the monitored characteristic to a remote entity.

### TECHNICAL FIELD

The subject disclosure generally relates to irrigation, and more specifically to a system and methodology that facilitates commercial scale irrigation via plant injection.

### BACKGROUND

In order to farm deciduous crops (i.e., almonds, pistachios, walnuts, wine grapes, etc.) in arid climates, the application of water to the soil is generally required. Here, the root system mines the soil for this moisture in order to sustain plant life. Not all water applied to the soil is utilized, however, which results in the inefficient and wasteful use of a precious and scarce commodity.

Irrigation, for example, is the artificial application of water to the land or soil, and is used to assist in the growing of agricultural crops in dry areas and during periods of inadequate rainfall. Conventional types of irrigation include surface irrigation, localized irrigation, and sprinkler irrigation. With surface irrigation, also known as “furrow” or “flood” irrigation, water is flood across the surface of agricultural lands, wherein the water seeps through the soil. With localized irrigation, also known as “drip” or “subsurface” irrigation, water is distributed under low pressure through a piped network in a pre-determined pattern, and applied as a small discharge to a desired area. With sprinkler irrigation, which is commonly used for row crops (e.g., soybeans, corn, etc.) and less commonly used in permanent crops, water is piped to one or more central locations within a field and distributed by overhead high pressure sprinklers.

Each of the above systems are inefficient, however, since much of the water evaporates or is otherwise absorbed by the soil before reaching the roots of a crop. Accordingly, a more water efficient irrigation system which overcomes these limitations is desired. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with commercial scale irrigation via plant injection. In one such aspect, an irrigation system is provided, which includes a pressurized fluid source having at least one fluid output line, and a plurality of fluid lines coupled to the at least one fluid output line. For this embodiment, each of the plurality of fluid lines comprise an injectable nozzle configured to facilitate an injection of fluid into an outer xylem layer of a dicotyledon plant. Also, the pressurized fluid source is configured to maintain a pressure level that facilitates the injection of fluid via a transpiration of the dicotyledon plant.

In another aspect, a computer-readable storage medium is provided, which includes a memory component configured to store computer-readable instructions. The computer-readable instructions include instructions for performing various acts, which include maintaining a pressure level at a pressurized fluid source. Here, the pressurized fluid source includes at least one fluid output line coupled to a plurality of fluid lines in which each of the plurality of fluid lines comprises an injectable nozzle. The acts further include monitoring a characteristic associated with an injection of fluid from the injectable nozzle into an outer xylem layer of a dicotyledon plant, and communicating the monitored characteristic associated with the injection of fluid to a remote entity. For this embodiment, the pressure level at the pressurized fluid source facilitates the injection of fluid via a transpiration of the dicotyledon plant.

In a further aspect, a method is provided, which includes maintaining a pressure level at a pressurized fluid source comprising at least one fluid output line coupled to a plurality of fluid lines in which each of the plurality of fluid lines comprises an injectable nozzle. The method further comprises injecting the injectable nozzle into an outer xylem layer of a dicotyledon plant. For this embodiment, the pressure level at the pressurized fluid source facilitates an injection of fluid from the injectable nozzle into the outer xylem layer of the dicotyledon plant via a transpiration of the dicotyledon plant.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary injectable nozzle in accordance with an aspect of the subject specification;

FIG. 2 illustrates an exemplary irrigation system with a single output pressurized fluid source according to an aspect of the subject specification;

FIG. 3 illustrates an exemplary irrigation system with a multiple output pressurized fluid source according to an aspect of the subject specification;

FIG. 4 is a flow diagram of an exemplary methodology that facilitates a commercial scale injection of plants in accordance with an aspect of the subject specification;

FIG. 5 illustrates a block diagram of an exemplary source device that facilitates implementing aspects disclosed herein;

FIG. 6 illustrates a block diagram of an exemplary plant device that facilitates implementing aspects disclosed herein;

FIG. 7 illustrates an exemplary environment that facilitates a commercial scale injection of plants in accordance with an aspect of the subject specification;

FIG. 8 is a flow diagram of an exemplary methodology that facilitates a commercial scale injection of plants in accordance with an aspect of the subject specification;

FIG. 9 is a block diagram representing exemplary non-limiting networked environments in which various embodiments described herein can be implemented; and

FIG. 10 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which overcomes the various limitations of conventional irrigation systems. The embodiments disclosed herein are directed towards overcoming such limitations by providing a commercial scale irrigation system that utilizes a plant injection mechanism (also referred to herein as xylem irrigation and ultra-micro irrigation). Moreover, various aspects directed towards the commercial scale injection of irrigation water, plant nutrients, pesticides, antifreeze, and fungicides are disclosed, wherein such injection is made directly into the dicotyledon plant vascular system (i.e., the xylem layer). To this end, although chemigation and fertigation via plant injection is generally known in the landscape/park industry (See e.g., www.arborjet.com), it should be noted that such injections have been limited to injections of individual plants, rather than commercial scale chemigation/fertigation. It should be further noted that conventional direct injection systems are limited to injecting individual monocotyledon plants for chemigation/fertigation purposes. Namely, conventional systems are not configured to support the direct injection of any type of plant for irrigation purposes, nor are they configured to support the direct injection of dicotyledon plants in particular for any purpose.

In an aspect disclosed herein, a pressurized irrigation system is contemplated, wherein the system is configured to provide water, fertilizer, antifreeze, and/or pesticides directly to the xylem layer of a plurality of dicotyledon plants (e.g., trees, vines, etc.). By way of background, it should be noted that dicotyledon plants create a negative pressure on the xylem tubes via the process of transpiration. Namely, as the plant transpires, water is drawn into the xylem, as needed by the plant. The system disclosed herein couples a constant pressurized fluid source to dicotyledon plants via injectable nozzles, wherein the transpiration process allows each plant to moderate the actual fluid consumption as determined by the climate and agronomic cycle. For instance, a plant may draw more water during the day when the temperature is warmer than at night cycle when the temperature is cooler.

As previously stated, conventional direct injection systems are limited to injecting individual monocotyledon plants for chemigation/fertigation purposes. To this end, it should be noted that monocotyledon plants have a distinctive vascular tissue arrangement known as an atactostele in which the vascular tissue is scattered. Accordingly, water injection tubes of conventional direct injection systems may be injected at random layers within the fibrous tree trunk, without concern for exacting placement. Dicotyledon such as almonds, grape vines, etc., however, do not have a vascular system arranged throughout the plant trunk. Instead, the water transporting tissue in dicotyledon plants is in the outer ring called the xylem. This xylem ring is what many refer to as growth rings. To implement the disclosed injection system on dicotyledon plants, a precise placement of the injection nozzles into the outer xylem layer is thus contemplated.

### Exemplary Embodiments

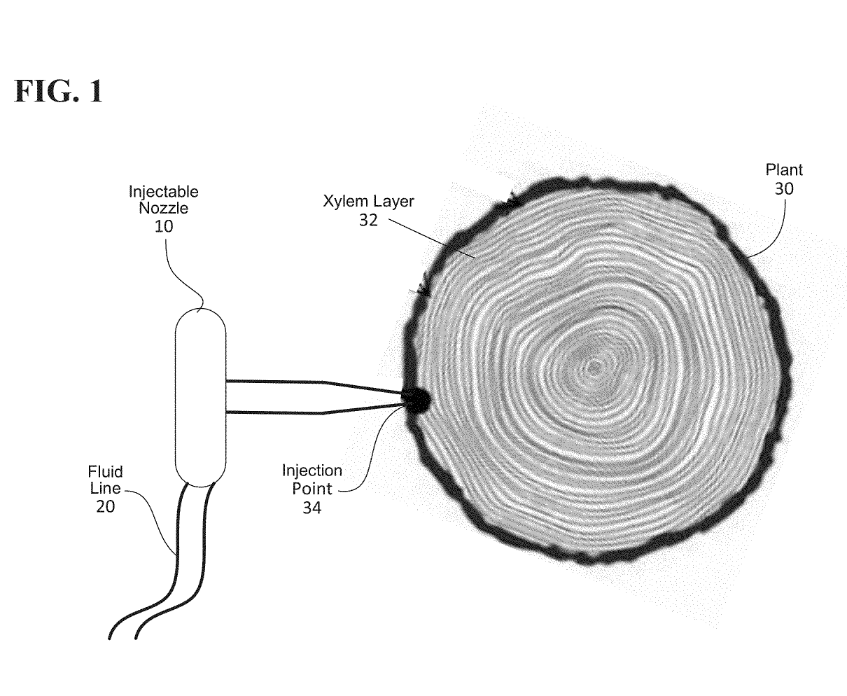

Various exemplary embodiments that implement the disclosed direct injection aspects are now provided. In FIG. 1, for instance, an exemplary injectable nozzle is provided in accordance with an aspect of the subject specification. As illustrated, it is contemplated that such an injectable nozzle 20 is coupled to a fluid line 10, wherein fluid received via the fluid line 10 is directly injected into a plant 30. As previously stated, particular aspects disclosed herein are directed towards injecting dicotyledon plants, which have a unique vascular tissue arrangement. Accordingly, because the water transporting tissue in dicotyledon plants is in the outer xylem layer (i.e., outer ring), aspects disclosed herein contemplate the precise placement of injection nozzle 20 at an injection point 34 on the outer xylem layer 32 of a plant 30, as shown. Once injected, the injectable nozzle 20 serves as a conduit between the outer xylem layer 32 of the plant 30 and a source of fluids (e.g., water, fertilizer, antifreeze, pesticides, etc.), wherein the plant 30 pulls fluids from the source, as needed, via the transpiration process.

It is contemplated that any of various types of fluids may be injected according to the aspects disclosed herein. For instance, in addition to water, fertilizers and/or pesticides may be injected directly into the outer xylem layer 32 of a plant 30. In another aspect of the disclosure, it is contemplated that an antifreeze solution may also be injected. To this end, it should be noted that propylene glycol has been used in ice cream as an antifreeze product to prevent ice crystals from developing. Similarly, it is contemplated that a food grade antifreeze product may be injected into citrus and other frost sensitive crops according to the aspects disclosed herein. (See also, U.S. Pat. No. 3,334,012, which is hereby incorporated by reference in its entirety).

It is further contemplated that a varying number of injection points may be included in a particular plant, depending upon the type and age of the tree/vine. Namely, although a single injection point will be adequate for most trees, 2-6 injection points per plant may be desirable to provide fail-safe redundancy in case of injection clogging.

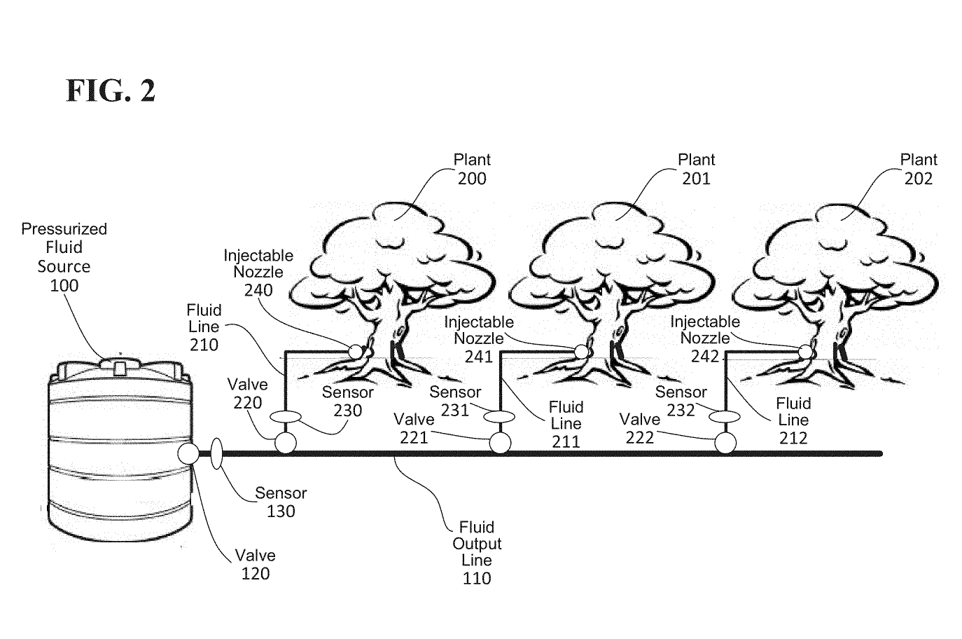

Various novel aspects are now disclosed with respect to providing fluids via direct injection to plants on a commercial scale. FIG. 2, for instance, illustrates an exemplary commercial scale direct injection system according to an aspect of the subject specification. As illustrated, an irrigation system is provided, which includes a pressurized fluid source 100 having a fluid output line 110 coupled to a plurality of fluid lines 210, 211, and 212. For this particular embodiment, each of the plurality of fluid lines 210, 211, and 212 have an injectable nozzle 240, 241, and 242 configured to facilitate an injection of fluid into an outer xylem layer of various dicotyledon plants 200, 201, and 202, as shown.

To facilitate the injection of fluid via a transpiration of the dicotyledon plants 200, 201, and 202, the pressurized fluid source 100 is configured to maintain a particular pressure level. For instance, a pressure level between 5-50 PSI may be utilized to maintain a continuous flow of fluids to the injection points, wherein such fluids are only made available to the injection points, rather than forced through the injection points, so that the respective plant vascular systems can uptake fluids, as needed, via the negative pressure created by the photosynthesis process of each plant. In order to maintain such pressure level, it is contemplated that valves and sensors may be deployed across the disclosed irrigation system. For instance, the pressurized fluid source 100 may include a valve 120 and/or sensor 130 coupled to the fluid output line 110, as shown. Within such embodiment, the valve 120 may be configured to adjust an output of fluid from the fluid output line 110, whereas the sensor 130 may be configured to monitor a fluid output characteristic associated with the fluid output line 110 (e.g., a pressure level at the pressurized fluid source 100, a fluid output rate, etc.). Similarly, each of the plurality of fluid lines 210, 211, and 212 may respectively include a valve 220, 221, and 222, and/or sensor 230, 231, and 232, as shown. For these embodiments, any of valves 220, 221, and/or 222 may be configured to respectively adjust an output of fluid from the fluid lines 210, 211, and/or 212, whereas any of sensors 230, 231, and/or 232 may be configured to monitor a fluid output characteristic respectively associated with the fluid lines 210, 211, and/or 212 (e.g., a pressure level, a fluid output rate, a transpiration frequency, a temperature measurement, a precipitation measurement, etc.).

With respect to sensors 230, 231, and/or 232, it should be appreciated that any of various sensors well known in the art may be utilized to remotely monitor the irrigation system disclosed herein. For instance, a sap flow tool (developed by ICT International Pty Ltd) can perform sap flow calculations on data from sensors based on a Heat Ratio Method (HRM) or a Heat Field Deformation (HFD), wherein HRM sensors improve on Compensation Heat Pulse Method (CHPM) sensors by allowing very slow flow rates and even reverse sap flow to be measured (i.e., allows water flows to be monitored in stems and roots of a wide range of different species, sizes and environmental conditions, including drought), and wherein HFD sensors are ideally suited for measurements of extended radial sap flow profiles to accurately map the hydraulic architecture of trees. (For more information, see http://www.sapflowtool.com/SapFlowToolSensors.html). Plant stress monitors are also well known in the art including, for example, the plant stress monitors disclosed in “Potential to Monitor Plant Stress Using Remote Sensing Tools” by A. Ramoelo, et. al (Published in Journal of Arid Environments, Volume 113, February 2015, Pages 134-144, which is hereby incorporated by reference in its entirety).

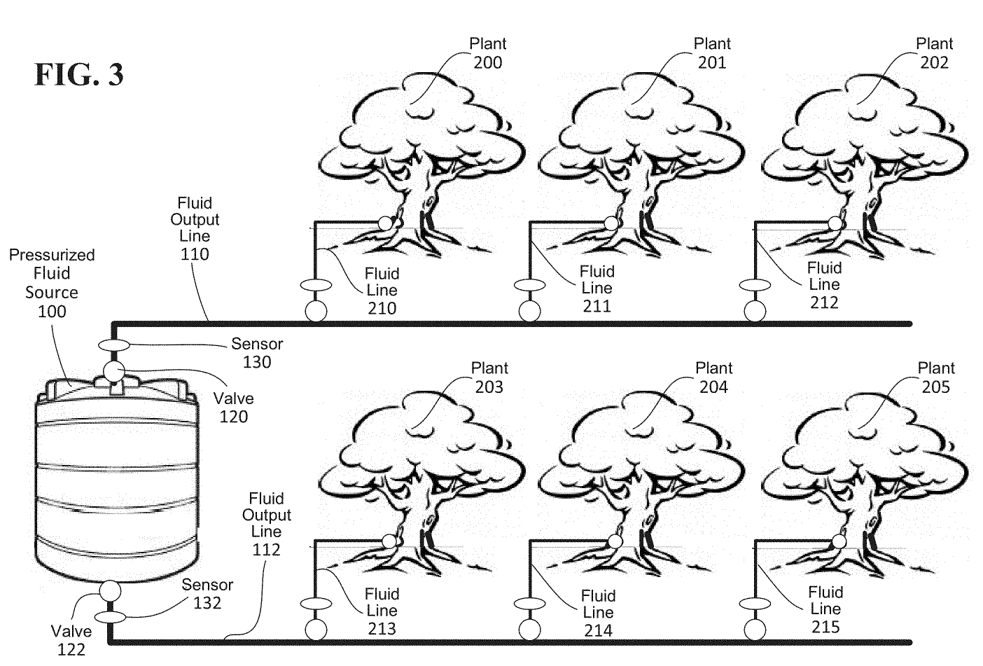

In another aspect of the disclosure, it is contemplated that a pressurized fluid source may be configured to include multiple output lines. FIG. 3, for instance, illustrates an exemplary irrigation system with a multiple output pressurized fluid source according to an aspect of the subject specification. Here, the pressurized fluid source 100 provided in FIG. 2 has been reconfigured to include an additional output line 112 to accommodate additional plants 203, 204, and 205, as shown, wherein the pressure within the pressurized fluid source 100 may be monitored and adjusted by sensors and valves respectively coupled to each output line. For this particular example, the pressurized fluid source 100 includes a first fluid output line 110 coupled to a first set of fluid lines 210, 211, and 212, and further includes a second fluid output line 112 coupled to a second set of fluid lines 213, 214, and 215. As illustrated, a valve 120 and/or sensor 130 may be coupled to the first fluid output line 110, and a valve 122 and/or sensor 132 may be coupled to the second fluid output line 112. Within such embodiment, valves 120 and 122 may be configured to respectively adjust an output of fluid from the first and second fluid output lines 110 and 112, whereas sensors 130 and 132 may be configured to monitor a fluid output characteristic respectively associated with the fluid output lines 110 and 112 (e.g., a pressure level, a fluid output rate, etc.).

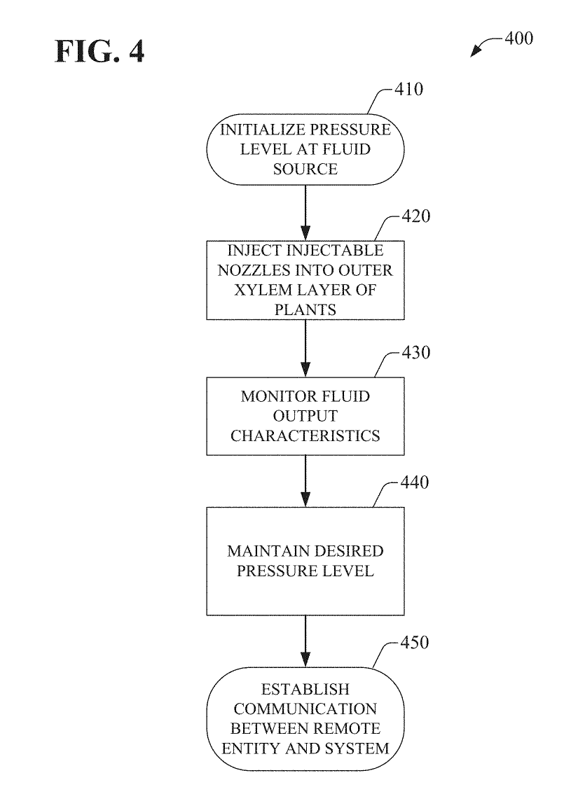

Referring next to FIG. 4, a flow diagram is provided of an exemplary methodology that facilitates a commercial scale injection of plants in accordance with an aspect of the subject specification. It should be appreciated that such methodology comprises a series of acts that may be performed in conjunction with any of various components, including the aforementioned components described with reference to FIGS. 1-3. As illustrated in FIG. 4, process 400 begins at act 410 where the pressure level at the fluid source (e.g., pressurized fluid source 100) is initialized. Process 400 then proceeds to act 420 where a plurality of dicotyledon plants (e.g., plants 200, 201, 202, 203, 204, and/or 205) are respectively injected with injectable nozzles (e.g., injectable nozzle 10). To facilitate injections, holes are drilled into each of the plurality of dicotyledon plants, wherein the depths of such holes may vary according to the type of plant. Namely, holes are drilled so as to allow each injectable nozzle to inject fluid (e.g., water, fertilizer, antifreeze, pesticides, etc.) directly into the respective plant's outer xylem layer (e.g., injection point 34).

Once each of the plurality of plants are injected, process 400 proceeds to act 430 where various characteristics associated with fluid output are monitored. For instance, to facilitate the injection of fluid into the plant via transpiration, it is contemplated that maintaining the pressure level at the pressurized fluid source within a particular range will be desirable. To this end, it is further contemplated that such pressure level will vary depending on any of various factors including, but not limited to, the type of plant, number of plants, fluid output rate, pressure level, etc. Accordingly, act 430 may include utilizing sensors (e.g., sensor 130) to monitor the pressure level at the pressurized fluid source, for instance, and/or any of the various characteristics related to the pressure level. Similarly, because it may be desirable to monitor characteristics at each plant (e.g., a pressure level, a fluid output rate, a transpiration frequency, a temperature measurement, a precipitation measurement, etc.), act 430 may include utilizing sensors proximate to each plant (e.g., sensors 230, 231, and/or 232) to monitor such characteristics.

Based on the monitoring performed at act 430, process 400 may then perform any of various adjustments at act 440 to maintain a desired pressure level at the pressurized fluid source and/or individual fluid lines. For instance, act 440 may include utilizing a valve at the pressurized fluid source (e.g., valve 120) to adjust an output of fluid from the source's fluid output line, wherein the transpiration of each plant varies according to such adjustment. Similarly, adjustments can be made for individual plants, wherein act 440 includes utilizing a valve at the particular plant's fluid line (e.g., valve 220, 221, and/or 222) to adjust an output of fluid for each plant.

In a further aspect, it is contemplated that a user may want to remotely monitor various details of the disclosed irrigation system. Indeed, rather than manually inspecting whether each individual injection is functioning properly, aspects disclosed herein contemplate establishing a communication at act 450 between a remote entity (e.g., personal computer, smartphone, etc.) and at least one of the pressurized fluid source or at least one of the plurality of fluid lines. Such communication may, for instance, include a sensor communication, wherein data collected from any of the aforementioned sensors is relayed to a user's smartphone. Rather than providing the user with actual sensor data, it is also contemplated that threshold measurements for particular characteristics may be set, wherein the user receives a notification whenever such threshold measurements are exceeded (e.g., whenever fluid into a particular plant falls below a minimum threshold). To this end, control communications are also contemplated, which allow a user to remotely control/adjust various aspects of the system. For instance, upon receiving a notification that precipitation measurements have exceeded a predetermined threshold (i.e., heavy rainfall), a user may transmit a valve control communication to the system, wherein such communication shuts off water to the various plants (e.g., by closing the valve coupled to the pressurized fluid source).

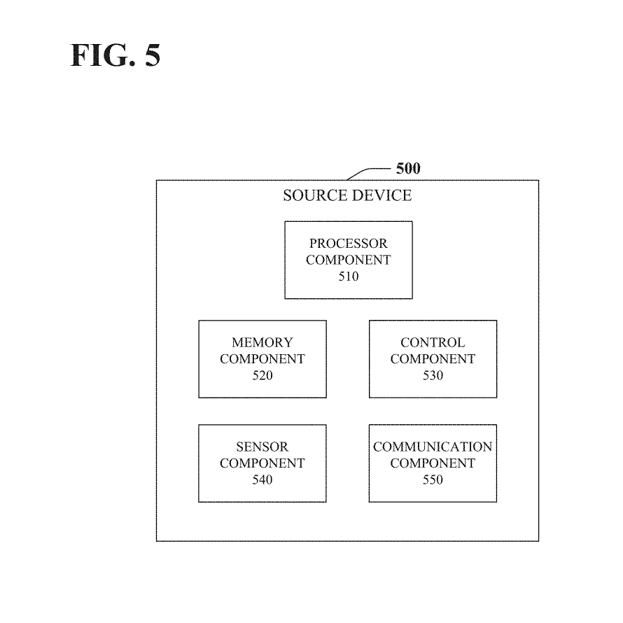

To facilitate various aspects disclosed herein, it may be desirable to couple a computing device to the pressurized fluid source. Referring next to FIG. 5, an exemplary block diagram of such a device is provided. As illustrated, source device 500 may include a processor component 510, a memory component 520, a control component 530, a sensor component 540, and a communication component 550. Components 510-550 may reside together in a single location or separately in different locations in various combinations, including, for example, a configuration in which at least one of the aforementioned components reside in a cloud.

In one aspect, processor component 510 is configured to execute computer-readable instructions related to performing any of a plurality of functions. Processor component 510 can be a single processor or a plurality of processors which analyze and/or generate information utilized by memory component 520, control component 530, sensor component 540, and/or communication component 550. Additionally or alternatively, processor component 510 may be configured to control one or more components of source device 500.

In another aspect, memory component 520 is coupled to processor component 510 and configured to store computer-readable instructions executed by processor component 510. Memory component 520 may also be configured to store any of a plurality of other types of data including data generated by any of control component 530, sensor component 540, and/or communication component 550. Memory component 520 can be configured in a number of different configurations, including as random access memory, battery-backed memory, Solid State memory, hard disk, magnetic tape, etc. Various features can also be implemented upon memory component 520, such as compression and automatic back up (e.g., use of a Redundant Array of Independent Drives configuration). In one aspect, the memory may be located on a network, such as a “cloud storage” solution.

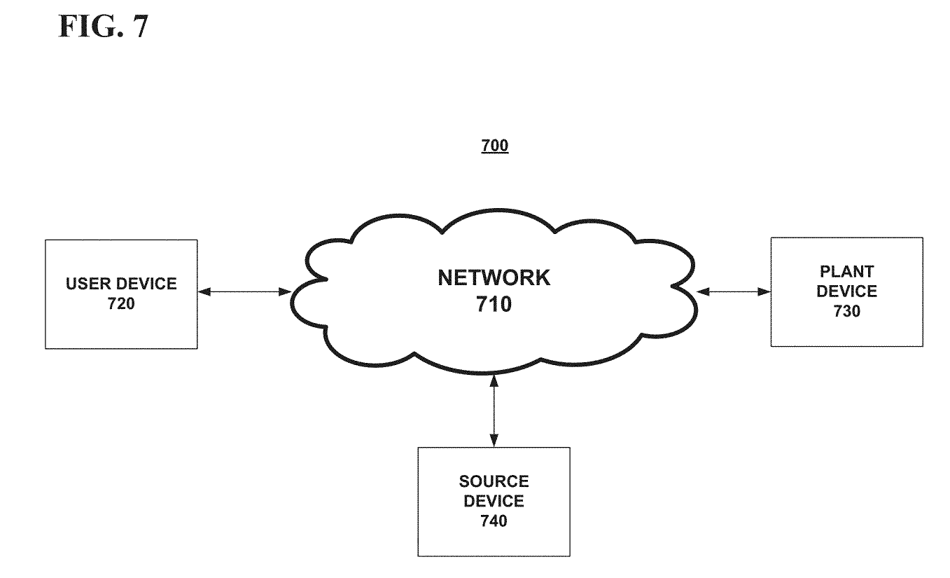

As illustrated, source device 500 may further comprise control component 530, sensor component 540, and communication component 550. Here, it is contemplated that communication component 550 may be used to interface source device 500 with external entities. For example, communication component 550 may be configured to receive and/or transmit data via a network (See e.g., FIG. 7). In a particular embodiment, communication component 550 is configured to facilitate a communication with a remote entity (e.g., a user's smartphone), wherein such communication may include a sensor communication and/or a control communication. For instance, sensor component 540 may include any of various types of sensors configured to monitor any of various types of characteristics (e.g., fluid output rate, pressure level, etc.), wherein communication component 550 is then configured to relay such data, and/or notifications related to such data, to a remote entity. Communication component 550 may then be further configured to receive control communications from a user, wherein control component 530 is configured to utilize such communications to control/adjust various aspects of the system (e.g., to adjust/control fluid output via a valve coupled to the pressurized fluid source.

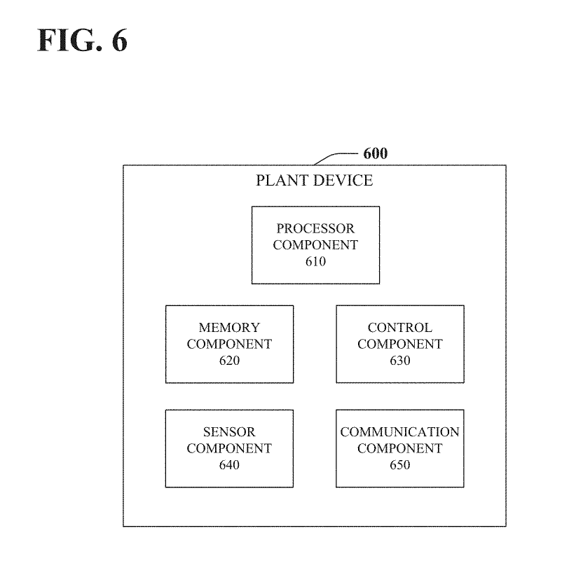

In another aspect, it is contemplated that a computing device may be coupled to fluid lines corresponding to particular plants. Referring next to FIG. 6, an exemplary block diagram of such a device is provided. As illustrated, plant device 600 may include a processor component 610, a memory component 620, a control component 630, a sensor component 640, and a communication component 650. Components 610-650 may reside together in a single location or separately in different locations in various combinations, including, for example, a configuration in which at least one of the aforementioned components reside in a cloud.

Here, it should be appreciated that each of components 610-650 are substantially similar to components 510-550 of source device 500. For instance, it is contemplated that communication component 650 may be used to interface plant device 600 with external entities, wherein communication component 650 may be configured to receive and/or transmit data via a network (See e.g., FIG. 7). Similar to communication component 550, communication component 650 is configured to facilitate a communication with a remote entity (e.g., a user's smartphone), wherein such communication may include a sensor communication and/or a control communication. For instance, sensor component 640 may include any of various types of sensors configured to monitor any of various types of characteristics (e.g., a pressure level, a fluid output rate, a transpiration frequency, a temperature measurement, a precipitation measurement, etc.), wherein communication component 650 is then configured to relay such data, and/or notifications related to such data, to a remote entity. Communication component 650 may then be further configured to receive control communications from a user, wherein control component 630 is configured to utilize such communications to control/adjust various aspects of the system (e.g., to adjust/control fluid output via a valve coupled to the fluid line).

Turning now to FIG. 7, an exemplary environment that facilitates a commercial scale injection of plants is provided according to an embodiment. As illustrated, environment 700 includes user device 720, which may be coupled to plant device 730 and source device 740 via network 710 (e.g., the Internet). Within such embodiment, it is contemplated that user device 720 (e.g., a personal computer, mobile phone, tablet, etc.) is utilized by a user to communicate with plant device 730 and/or source device 740, wherein plant device 730 is substantially similar to plant device 600, and wherein source device 740 is substantially similar to source device 500. Namely, it is contemplated that user device 720 may be used to remotely control/monitor various aspects of plant device 730 and/or source device 740. For instance, user device 720 may be used to remotely monitor data collected by plant device 730 (e.g., a pressure level, a fluid output rate, a transpiration frequency, a temperature measurement, a precipitation measurement, etc.) and/or data collected by source device 740 (e.g., fluid output rate, pressure level, etc.). User device 720 may also be used to remotely control aspects of plant device 730 (e.g., a valve coupled to a plant's fluid line) and/or aspects of source device 740 (e.g., a valve coupled to the pressurized fluid source).

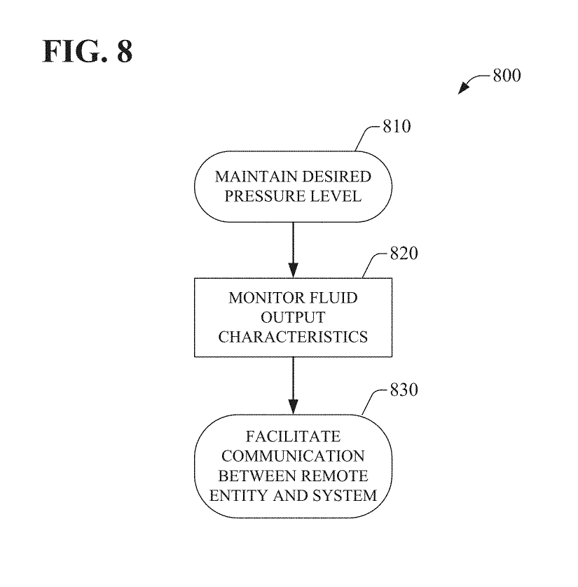

Referring next to FIG. 8, a flow chart illustrating an exemplary method that facilitates a commercial scale injection of plants according to an embodiment is provided. As illustrated, process 800 includes a series of acts that may be performed by an irrigation system that includes at least one computing device (e.g., user device 720, plant device 730, and/or source device 740) according to an aspect of the subject specification. For instance, process 800 may be implemented by employing a processor to execute computer executable instructions stored on a computer readable storage medium to implement the series of acts. In another embodiment, a computer-readable storage medium comprising code for causing at least one computer to implement the acts of process 800 is contemplated.

In general, it should be appreciated that process 800 facilitates a communication between a remote unit (e.g., user device 720) and a plant device 730 and/or source device 740. As illustrated, process 800 begins with a desired pressure level being maintained at act 810. Here, as previously stated, such pressure level facilitates the injection of fluid into a plant via transpiration, wherein the pressure level may correspond to a pressure level at a pressurized fluid source and/or a fluid line corresponding to a particular plant. At act 820, process 800 then monitors various characteristics associated with fluid output. Such monitoring may, for instance, monitoring whether the pressure level at the pressurized fluid source is within a desired range. Similarly, because it may be desirable to monitor characteristics at each plant (e.g., a pressure level, a fluid output rate, a transpiration frequency, a temperature measurement, a precipitation measurement, etc.), act 820 may include utilizing sensors proximate to each plant (e.g., sensors 230, 231, and/or 232) to monitor such characteristics. Process 800 then concludes at act 830 where a communication between the irrigation system and a remote entity (e.g., a user's smartphone) is facilitated. As previously stated, such communications may include sensor communications from the system to the remote entity, as well as control communications from the remote entity to the system.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

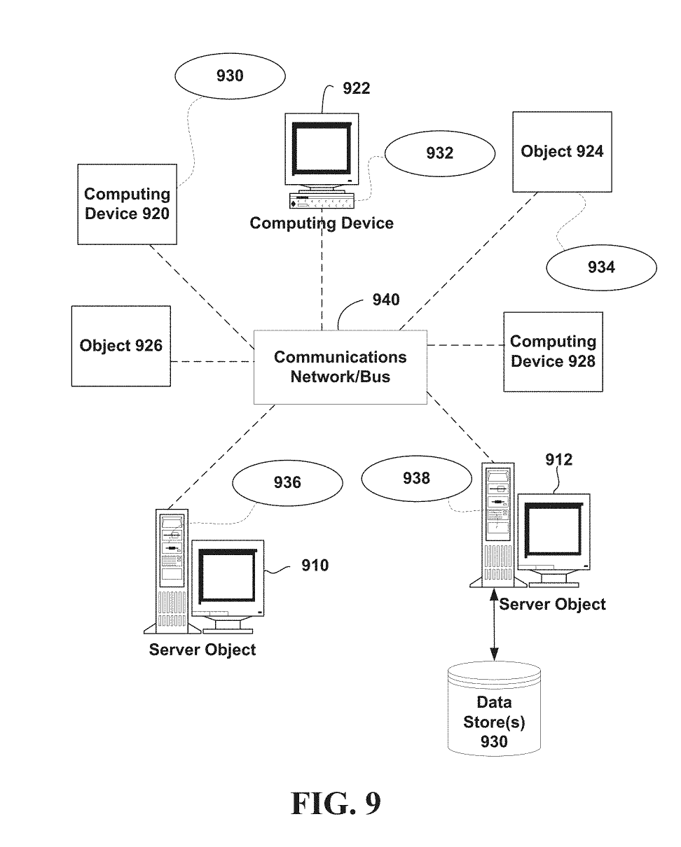

FIG. 9 provides a non-limiting schematic diagram of an exemplary networked or distributed computing environment. The distributed computing environment comprises computing objects or devices 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects or devices 910, 912, etc. and computing objects or devices 920, 922, 924, 926, 928, etc. may comprise different devices, such as PDAs (personal digital assistants), audio/video devices, mobile phones, MP3 players, laptops, etc.

Each computing object or device 910, 912, etc. and computing objects or devices 920, 922, 924, 926, 928, etc. can communicate with one or more other computing objects or devices 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each computing object or device 910, 912, etc. or 920, 922, 924, 926, 928, etc. can also contain an application, such as applications 930, 932, 934, 936, 938, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects or devices 910, 912, etc. can be thought of as servers where computing objects or devices 910, 912, etc. provide data services, such as receiving data from computing objects or devices 920, 922, 924, 926, 928, etc., storing of data, processing of data, transmitting data to computing objects or devices 920, 922, 924, 926, 928, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 940 is the Internet, for example, the computing objects or devices 910, 912, etc. can be Web servers with which the computing objects or devices 920, 922, 924, 926, 928, etc. communicate via any of a number of known protocols, such as HTTP. As mentioned, computing objects or devices 910, 912, etc. may also serve as computing objects or devices 920, 922, 924, 926, 928, etc., or vice versa, as may be characteristic of a distributed computing environment.

### Exemplary Computing Device

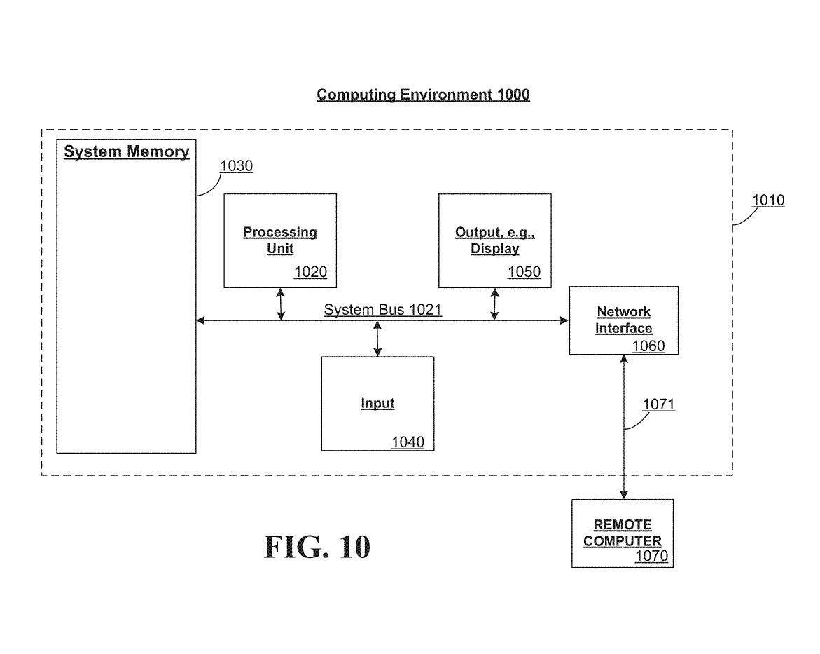

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 10 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 10 thus illustrates an example of a suitable computing system environment 1000 in which one or more of the embodiments may be implemented, although as made clear above, the computing system environment 1000 is only one example of a suitable computing environment and is not intended to suggest any limitation as to the scope of use or functionality of any of the embodiments. The computing environment 1000 is not to be interpreted as having any dependency or requirement relating to any one or combination of components illustrated in the exemplary operating environment 1000.

With reference to FIG. 10, an exemplary remote device for implementing one or more embodiments herein can include a general purpose computing device in the form of a handheld computer 1010. Components of handheld computer 1010 may include, but are not limited to, a processing unit 1020, a system memory 1030, and a system bus 1021 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, memory 1030 may also include an operating system, application programs, other program modules, and program data.

A user may enter commands and information into the computer 1010 through input devices 1040 A monitor or other type of display device is also connected to the system bus 1021 via an interface, such as output interface 1050. In addition to a monitor, computers may also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1071, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. An irrigation system, comprising:
a pressurized fluid source, the pressurized fluid source including at least one fluid output line; and
a plurality of fluid lines coupled to the at least one fluid output line, each of the plurality of fluid lines comprising an injectable nozzle,
wherein the injectable nozzle is configured to facilitate an injection of fluid into an outer xylem layer of a dicotyledon plant, and
wherein the pressurized fluid source is configured to maintain a pressure level that facilitates the injection of fluid via a transpiration of the dicotyledon plant.

2. The irrigation system of claim 1, wherein the pressurized fluid source is configured to output at least one of water, chemigation fluid, or fertigation fluid.

3. The irrigation system of claim 1, further comprising a communication component configured to facilitate a communication between a remote entity and at least one of the pressurized fluid source or at least one of the plurality of fluid lines.

4. The irrigation system of claim 3, wherein the communication is a wireless communication.

5. The irrigation system of claim 3, wherein the pressurized fluid source includes a sensor coupled to the at least one fluid output line, and wherein the communication is a sensor communication corresponding to a fluid output characteristic monitored by the sensor.

6. The irrigation system of claim 3, wherein the pressurized fluid source includes a valve coupled to the at least one fluid output line, and wherein the communication is a valve control communication configured to adjust an output of fluid from the at least one fluid output line.

7. The irrigation system of claim 3, wherein the pressurized fluid source includes a plurality of fluid output lines respectively coupled to subsets of the plurality of fluid lines, and wherein a sensor is coupled to at least one of the plurality of fluid output lines, the communication being a sensor communication corresponding to a fluid output characteristic monitored by the sensor.

8. The irrigation system of claim 3, wherein the pressurized fluid source includes a plurality of fluid output lines respectively coupled to subsets of the plurality of fluid lines, and wherein a valve is coupled to at least one of the plurality of fluid output lines, the communication being a valve control communication configured to adjust an output of fluid from the at least one of the plurality of fluid output lines.

9. The irrigation system of claim 3, further comprising a sensor coupled to at least one of the plurality of fluid lines, wherein the communication is a sensor communication corresponding to a fluid output characteristic monitored by the sensor.

10. The irrigation system of claim 3, further comprising a valve coupled to at least one of the plurality of fluid lines, wherein the communication is a valve control communication configured to adjust an output of fluid from the at least one of the plurality of fluid lines.

11. A method, comprising:
maintaining a pressure level at a pressurized fluid source, the pressurized fluid source including at least one fluid output line coupled to a plurality of fluid lines, wherein each of the plurality of fluid lines comprises an injectable nozzle; and
injecting the injectable nozzle into an outer xylem layer of a dicotyledon plant, the pressure level at the pressurized fluid source facilitating an injection of fluid from the injectable nozzle into the outer xylem layer of the dicotyledon plant via a transpiration of the dicotyledon plant.

12. The method of claim 11, wherein the pressurized fluid source includes a valve coupled to the at least one fluid output line, and wherein the maintaining comprises utilizing the valve to adjust an output of fluid from the at least one fluid output line, wherein the transpiration of the dicotyledon plant varies according to an adjustment of the output of fluid.

13. The method of claim 11, further comprising utilizing a valve to adjust an output of fluid from at least one of the plurality of fluid lines, wherein the transpiration of the dicotyledon plant varies according to an adjustment of the output of fluid.

14. The method of claim 11, further comprising establishing a communication between a remote entity and at least one of the pressurized fluid source or at least one of the plurality of fluid lines.

15. The method of claim 14, wherein the communication comprises at least one of a control communication or a sensor communication.

16. A computer-readable storage medium, comprising:
a memory component configured to store computer-readable instructions, the computer-readable instructions including instructions for performing the following acts:
maintaining a pressure level at a pressurized fluid source, the pressurized fluid source including at least one fluid output line coupled to a plurality of fluid lines, wherein each of the plurality of fluid lines comprises an injectable nozzle;
monitoring a characteristic associated with an injection of fluid from the injectable nozzle into an outer xylem layer of a dicotyledon plant, the pressure level at the pressurized fluid source facilitating the injection of fluid via a transpiration of the dicotyledon plant; and
communicating the monitored characteristic associated with the injection of fluid to a remote entity.

17. The computer-readable storage medium of claim 16, wherein the monitored characteristic is at least one of the pressure level at the pressurized fluid source, a fluid injection rate, a transpiration frequency, a temperature proximate to the dicotyledon plant, or a precipitation proximate to the dicotyledon plant.

18. The computer-readable storage medium of claim 16, wherein the monitored characteristic is a determination of whether the characteristic associated with an injection of fluid exceeds a threshold, and wherein the communicating comprises notifying the remote entity when the threshold is exceeded.

19. The computer-readable storage medium of claim 16, wherein the pressurized fluid source includes a valve coupled to the at least one fluid output line, and wherein the communicating further comprises a valve control communication configured to adjust an output of fluid from the at least one fluid output line.

20. The computer-readable storage medium of claim 16, wherein at least one of the plurality of fluid lines is coupled to a valve, and wherein the communicating further comprises a valve control communication configured to adjust an output of fluid from the at least one of the plurality of fluid lines.
